(19) United States
(12) Patent Application Publication
(10) Pub. No.: US 2013/0135537 A1
(43) Pub. Date: May 30, 2013

(54) ILLUMINATING DEVICE, LIQUID CRYSTAL DISPLAY DEVICE AND TELEVISION RECEIVING DEVICE

(71) Applicant: Yasumori Kuromizu, Osaka-shi (JP)

(72) Inventor: Yasumori Kuromizu, Osaka-shi (JP)

(73) Assignee: SHARP KABUSHIKI KAISHA, Osaka-shi, Osaka (JP)

(21) Appl. No.: 13/812,958

(22) PCT Filed: May 18, 2011
(86) PCT No.: PCT/JP2011/061372

§ 371 Date: Jan. 29, 2013

(30) Foreign Application Priority Data
Aug. 6, 2010 (JP) 2010-176936

(51) Int. Cl. F21V 8/00; G02F 1/1335

(52) U.S. Cl. CPC G02B 6/0011; G02F 1/133602
USPC 348/790; 349/61; 362/613

(57) ABSTRACT

Provided is an illuminating device capable of preventing luminance unevenness from developing therein. An illuminating device (1) includes a container-shaped backlight chassis (4), a reflection sheet (6) on a bottom plate (41) of the backlight chassis, a light guide plate (7) on the reflection sheet, light-emitting boards (5) sandwiched between wall plates (42) of the chassis and the light guide plate and including light-emitting elements (51) and a non-light-emitting element (54) on wiring boards (52), and a frame-shaped frame (11) arranged to cover the chassis. The reflection sheet includes covering pieces (62) on its peripheral portions that erect with respect to the bottom plate of the chassis to cover surfaces of the non-light-emitting elements.

### TECHNICAL FIELD

The present invention relates to an illuminating device, a liquid crystal display device including the illuminating device, and a television receiving device including the liquid crystal display device.

### BACKGROUND ART

A transmissive or transflective liquid crystal display device includes a liquid crystal display panel and an illuminating device (a so-called backlight) disposed behind the liquid crystal display panel. In this type of liquid crystal display device, planar light emitted from the illuminating device is used to display an image on a display screen of the liquid crystal display panel.

An edge (side) light type illuminating device is known as the illuminating device, which has a configuration that light-emitting boards such as LED (Light Emitting Diode) boards, which include long wiring boards on which a plurality of LEDs (Light Emitting Diodes) are aligned, are disposed along end faces of a light guide plate that defines a clear plate made from an acrylate resin. In this type of illuminating device, the light emitted from the light-emitting boards is guided to enter the light guide plate from the end faces of the light guide plate, and thereby the entering light is made into planar light and emitted from a front face of the light guide plate. The light guide plate includes scattering members in a dot pattern that are disposed over a back face or a front face of the light guide plate and arranged to scatter the light that enters from the end faces of the light guide plate. In addition, a reflection sheet arranged to reflect the light is provided on the back face of the light guide plate. Thus, the light emitted from the light-emitting boards as described above is scattered or reflected by the scattering members or the reflection sheet, and is thus made into planar light and emitted from the front face (upper face) of the light guide plate.

For example, PTL 1 discloses this type of illuminating device.

### CITATION LIST

### Patent Literature

PTL 1: JP 2008-112663

### SUMMARY OF INVENTION

### Technical Problem

Not only the light-emitting elements such as the LEDs, but also power supply connectors, which are arranged to supply electric power to the light-emitting elements and have a convex shape, are provided on the light-emitting boards such as the LED boards used in the light illuminating device. For example, the power supply connectors are disposed at end portions in longitudinal directions of the light-emitting boards, and mainly include box-shaped housings preferably made from plastic, and terminals housed in the housings.

The power supply connectors are sometimes disposed close to the light guide plate (i.e., disposed facing the end faces of the light guide plate). For example, when a frame region surrounding the display screen of the liquid crystal display panel needs to be reduced in width, the light-emitting boards are disposed facing the end faces of the light guide plate so as not to lie off the end faces. In this case, the power supply connectors on the light-emitting boards are disposed at positions facing the end faces of the light guide plate. In some cases, notches are made by removing some portions of the light guide plate, and the light-emitting boards are disposed such that the power supply connectors are housed in the notches.

A description of a conventional illuminating device will be further provided with reference to FIGS. 17 and 18. FIG. 17 is a cross-sectional view showing a schematic configuration of a liquid crystal display device 100P including a conventional illuminating device 1P. FIG. 18 is a plan view showing a schematic configuration of the conventional illuminating device 1P.

The conventional liquid crystal display device 100P mainly includes the illuminating device 1P, a liquid crystal display panel 2P disposed on the illuminating device 1P, and a bezel 3P having a frame shape and disposed to cover peripheral portions of the liquid crystal display panel 2P to be fixed to the illuminating device 1P as shown in FIG. 17.

The illuminating device 1P mainly includes a backlight chassis 4P having a box (container) shape, a reflection sheet 6P laid on a bottom plate 41P of the backlight chassis 4P, a light guide plate 7P disposed on the bottom plate 41P on which the reflection sheet 6P is laid, LED boards 5 arranged to project light onto end faces 71P of the light guide plate 7P, optical sheets 8P to 10P disposed on an upper face 72P of the light guide plate 7P, and a frame 11P having a frame shape and arranged to cover the backlight chassis 4P as shown in FIGS. 17 and 18.

The LED boards 5P include long wiring boards 52P on which a plurality of LEDs 51P are mounted as shown in FIG. 18. The wiring boards 52P are fixed to wall plates 42P of the backlight chassis 4P so as to erect on the bottom plate 41P as shown in FIG. 17. Power supply connectors 54P are disposed at end portions in longitudinal directions of the light-emitting boards 5P so as to face end faces 711P of the light guide plate 7P as shown in FIGS. 17 and 18.

The light guide plate 7P that has a rectangular shape as a whole includes notches 75P on its four corners as shown in FIG. 18. The LED boards 5P are disposed in the backlight chassis 4P such that the power supply connectors 54P on the LED boards 5P are housed in the notches 75P while the LEDs 51P are disposed close to the end faces 71P of the light guide plate 7P.

In the illuminating device 1P, the LED boards 5P are disposed facing the two end faces 71P in a longitudinal direction of the light guide plate 7P as shown in FIG. 18. Two LED boards 5P are disposed (side by side) facing each end face 71P. FIG. 19 is an explanatory view for schematically showing luminance unevenness developing in the illuminating device 1P shown in FIG. 18. When the LEDs 51P on the LED boards 5P are turned on to emit light in the illuminating device 1P, the following problem arises: regions x on the four corners of the light guide plate 7P where the power supply connectors 54P are disposed become darker, and the luminance of the dark regions x becomes lower than that of the area around the dark regions x (i.e., a central area of the light guide plate 7P) as shown in FIG. 19.

The light emitted from the LEDs 51P on the LED boards 5P enters the light guide plate 7P from the two end faces 71P in the longitudinal direction, and travels toward the center of the light guide plate 7P while repeatedly reflected by front and back faces of the light guide plate 7P. A part of the light that enters from the end faces 71P gets (leaks) out of end faces 711P and 712P of the light guide plate 7P, which form (partition) the notches 75P, toward the outside where the power supply connectors 54P are located as shown in FIG. 17. Being made of members of low reflectivity, housings 55P that form outer portions of the power supply connectors 54P are inefficient in reflecting the light that has got out and making it reenter from the end faces 711P of the light guide plate 7P. For this reason, the dark regions x appear in the vicinities of the power supply connectors 54P as shown in FIG. 19.

The appearance of the dark regions x causes a problem of making unevenness (luminance unevenness) develop in planar light emitted from the illuminating device 1P.

An object of the present invention is to provide an illuminating device that includes a backlight chassis, a reflection sheet laid on a bottom face of the backlight chassis, a light guide plate disposed on the reflection sheet, and light-emitting elements disposed on inner walls of the backlight chassis, and is capable of preventing luminance unevenness from developing in light when illumination light that has entered from end faces of the light guide plate is emitted from an upper face of the light guide plate. Another object of the present invention is to provide a liquid crystal display device including the illuminating device. Another object of the present invention is to provide a television receiving device including the liquid crystal display device.

### Solution to Problem

To achieve the objects and in accordance with the purpose of the present invention, an illuminating device of the present invention includes a backlight chassis having a container shape that includes a bottom plate and wall plates surrounding the bottom plate, a reflection sheet laid on an inner bottom face of the backlight chassis, a light guide plate disposed on the reflection sheet and arranged to guide light that enters from its end faces inward and emit the light from its upper face, light-emitting boards, each of which includes a wiring board, a plurality of light-emitting elements aligned on the wiring board and a non-light-emitting element having a convex shape and disposed on the wiring board, wherein the light-emitting elements and the non-light-emitting elements are disposed between the wall plates of the backlight chassis and the light guide plate while facing the end faces of the light guide plate, and a frame having a frame shape and arranged to cover upper ends of the wall plates of the backlight chassis while covering peripheral portions of the light guide plate, wherein the reflection sheet includes covering pieces disposed on its peripheral portions and arranged to cover surfaces of the non-light-emitting elements on the light-emitting boards.

It is preferable that the non-light-emitting elements on the light-emitting boards define power supply connectors arranged to supply electric power to the light-emitting elements.

It is preferable that the power supply connectors are disposed at both ends of the light-emitting boards, and that the covering pieces arranged to cover the power supply connectors are disposed on four corners of the reflection sheet.

It is preferable that the light guiding plate includes notches disposed on its four corners, and arranged to house the power supply connectors on the light-emitting boards, and that the power supply connectors are covered by the covering pieces while housed in the notches.

It is preferable that the power supply connectors are disposed in the middle in longitudinal directions of the light-emitting boards, and that the covering pieces arranged to cover the power supply connectors are disposed at positions of the reflection sheet, the positions corresponding to the power supply connectors.

It is preferable that front ends of the covering pieces are sandwiched and held between the frame-shaped frame and the non-light-emitting elements on the light-emitting boards.

It is preferable that the covering pieces are provided by forming slits inside outer edges of the reflection sheet.

It is preferable that the covering pieces have any one of a triangular shape and a quadrangular shape.

It is preferable that the covering pieces have the shape of the letter L.

It is preferable that the covering pieces have any one of a convex shape and a concave shape.

It is preferable that the covering pieces have a taper shape such that the covering pieces taper to directions receding from the bottom plate.

It is preferable that the covering pieces have a bifurcated shape at their front ends.

It is preferable that the covering pieces have any one of a curved shape and a linear shape.

It is preferable that the covering pieces and the reflection sheet are of a multi-component assembled construction.

It is preferable that the covering pieces are fixed to the non-light-emitting elements with an adhesive member.

It is preferable that the covering pieces are sandwiched and fixed between the non-light-emitting elements and the light guide plate.

It is preferable that the reflection sheet has reflectivity higher than the surfaces of the non-light-emitting elements.

It is preferable that the light-emitting elements define light emitting diodes.

It is preferable that in terms of improvement in image sharpness, each of the light emitting diodes includes a blue light-emitting chip that is coated with a fluorescent material that has an emission peak wavelength in a yellow region, and the light emitting diodes are arranged to emit white light.

It is preferable that a sealing section for sealing the fluorescent material of each of the light emitting diodes has a dome structure.

It is preferable that the non-light-emitting elements define power supply connectors arranged to supply electric power to the light-emitting elements, having a convex shape, and disposed on the wiring boards.

In another aspect of the present invention, a liquid crystal display device includes the illuminating device described above, and a transmissive or transflective liquid crystal display panel, wherein the illuminating device is disposed on a back-face side of the liquid crystal display panel, and planar light emitted from the illuminating device is projected onto the back-face side of the liquid crystal display panel.

Yet, in another aspect of the present invention, a television receiving device includes the liquid crystal display device described above.

### Advantageous Effects of Invention

The illuminating device of the present invention has the configuration that the light that is emitted from the light-emitting elements on the light-emitting boards is guided into the light guide plate from the end faces of light guide plate and emitted from the upper face of light guide plate, while the peripheral portions of the light guide plate is covered by the frame-shaped frame that covers the upper ends of the wall plates of the backlight chassis, and the non-light-emitting elements on the wiring boards are covered by the covering pieces on the peripheral portions of the reflection sheet. Thus, the light emitted from the light-emitting elements on the light-emitting boards is effectively guided into the light guide plate while prevented from leaking out in the vicinities of the non-light-emitting elements on the wiring boards, so that the illuminating device of the present invention is capable of preventing luminance unevenness from developing therein. In addition, the liquid crystal display device including the illuminating device, and the television receiving device including the liquid crystal display device are capable of preventing luminance unevenness from developing therein.

### BRIEF DESCRIPTION OF DRAWINGS

FIG. 1 is an exploded perspective view showing a schematic configuration of a liquid crystal display device of a preferred embodiment of the present invention.

FIG. 2 is an explanatory view showing a schematic cross-sectional configuration of the liquid crystal display device shown in FIG. 1.

FIG. 3 is a plan view showing a schematic configuration of an illuminating device used in the liquid crystal display device.

FIG. 4 is an exploded perspective view showing a schematic configuration of a television receiving device of a preferred embodiment of the present invention.

FIG. 5 is a plan view showing a schematic configuration of a reflection sheet 6A that is used in an illuminating device of another preferred embodiment of the present invention.

FIG. 6 is a plan view showing a schematic configuration of a reflection sheet 6B of another preferred embodiment of the present invention.

FIG. 7 is a plan view showing a schematic configuration of a reflection sheet 6C of another preferred embodiment of the present invention.

FIG. 8 is a plan view showing a schematic partial configuration of a reflection sheet 6D of another preferred embodiment of the present invention.

FIG. 9 is a plan view showing a schematic partial configuration of a reflection sheet 6E of another preferred embodiment of the present invention.

FIG. 10 is a plan view showing a schematic partial configuration of a reflection sheet 6F of another preferred embodiment of the present invention.

FIG. 11 is a plan view showing a schematic partial configuration of a reflection sheet 6G of another preferred embodiment of the present invention.

FIG. 12 is a plan view showing a schematic partial configuration of a reflection sheet 6H of another preferred embodiment of the present invention.

FIG. 13 is a plan view showing a schematic partial configuration of a reflection sheet 6I of another preferred embodiment of the present invention.

FIG. 14 is a plan view showing a schematic partial configuration of a reflection sheet 6J of another preferred embodiment of the present invention.

FIG. 15 is a plan view showing a schematic partial configuration of a reflection sheet 6K of another preferred embodiment of the present invention.

FIG. 16 is an explanatory view showing a schematic cross-sectional configuration of a liquid crystal display device 100A of another preferred embodiment of the present invention.

FIG. 17 is a cross-sectional view showing a schematic configuration of a liquid crystal display device including a conventional illuminating device.

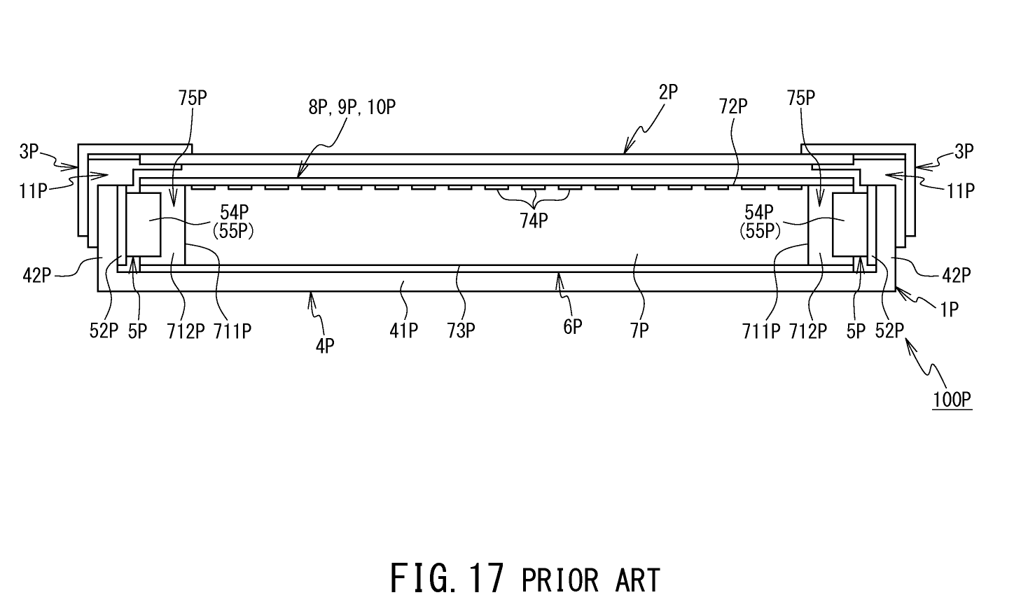

FIG. 18 is a plan view showing a schematic configuration of the conventional illuminating device used in the liquid crystal display device.

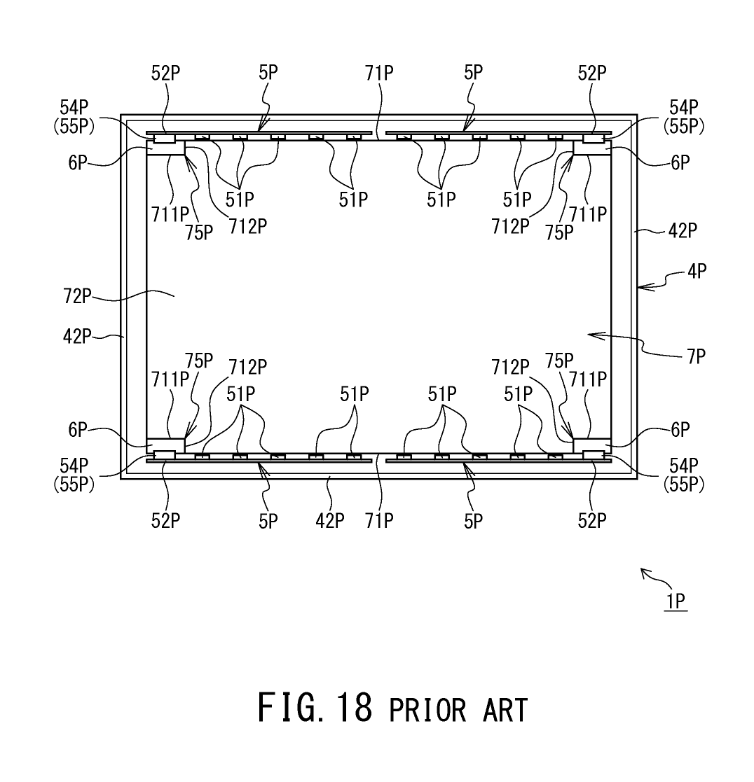

FIG. 19 is an explanatory view for schematically showing luminance unevenness developing in the illuminating device shown in FIG. 18.

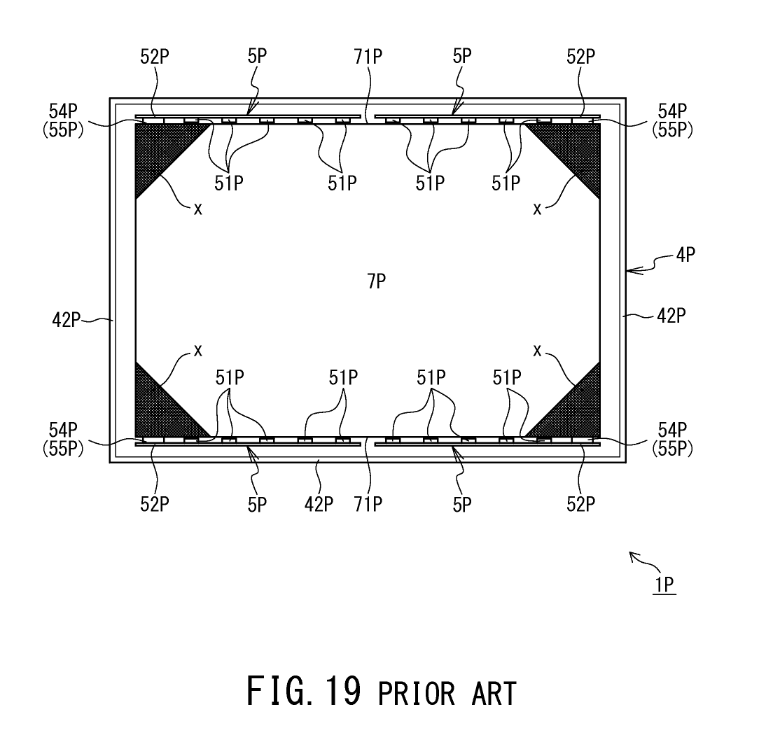

### DESCRIPTION OF EMBODIMENTS

Detailed descriptions of an illuminating device and a liquid crystal display device of preferred embodiments of the present invention will now be provided with reference to the accompanying drawings. The present invention shall not be construed as limited to the preferred embodiments described in the present specification. Components that have the same functions are explained once, providing the same reference numerals to the components in the drawings and the present specification.

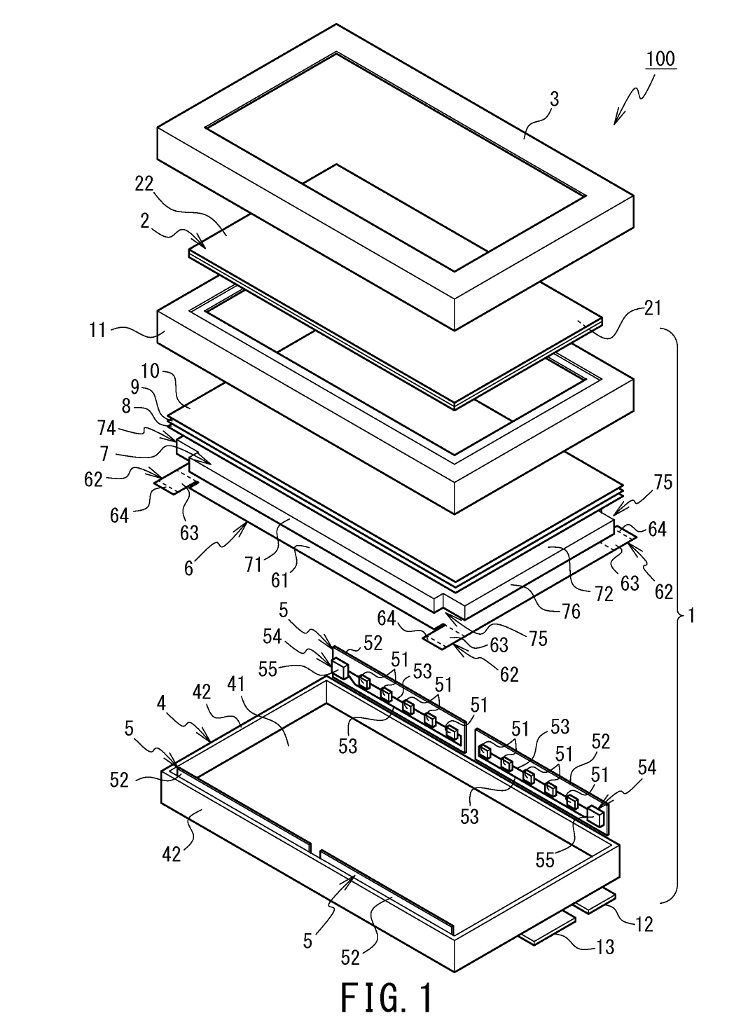

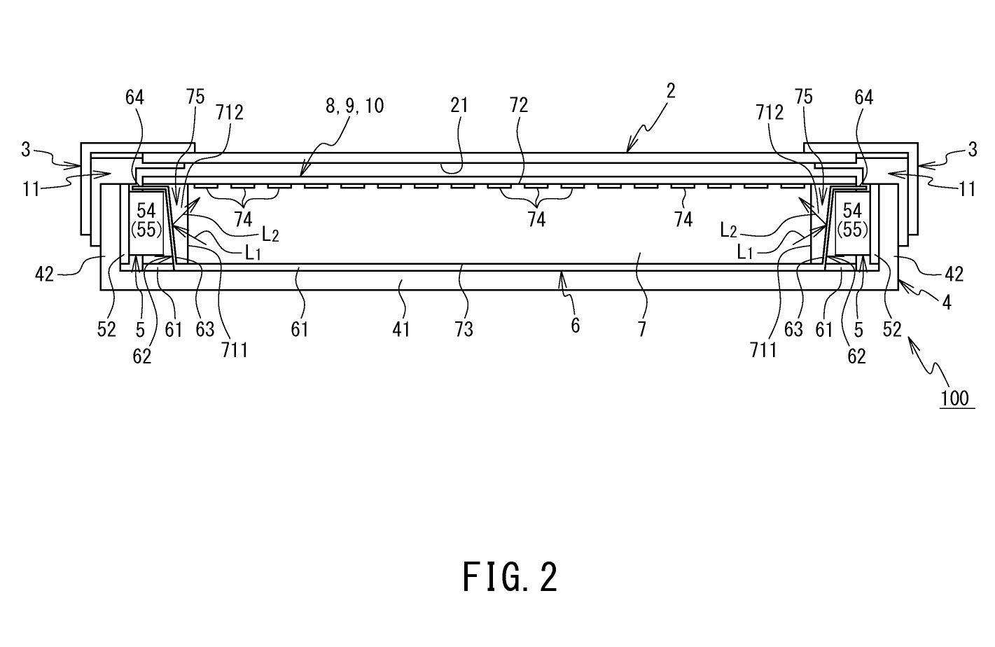

FIG. 1 is an exploded perspective view showing a schematic configuration of a liquid crystal display device 100 of a preferred embodiment of the present invention. FIG. 2 is an explanatory view showing a schematic cross-sectional configuration of the liquid crystal display device 100. The liquid crystal display device 100 includes an illuminating device 1. The liquid crystal display device 100 includes the illuminating device 1, a liquid crystal display panel 2, and a bezel 3, which are disposed in this order from the bottom as shown in FIG. 1.

The illuminating device 1 is a so-called edge light type illuminating device, and includes a backlight chassis 4 having a box (container) shape, LED boards (light-emitting boards) 5, a reflection sheet 6, a light guide plate 7, optical sheets 8 to 10, and a frame 11, which are disposed in this order from the bottom as shown in FIG. 1.

The backlight chassis 4 preferably defines a box (container) of low height prepared by bending a metal plate made from aluminum. The backlight chassis 4 includes a bottom plate 41 having a rectangular shape, and wall plates 42 that erect on the bottom plate 41 so as to surround the bottom plate 41 as shown in FIGS. 1 and 2. The backlight chassis 4 houses the LED boards (light-emitting boards) 5, the reflection sheet 6, the light guide plate 7, and the optical sheets 8 to 10.

The LED boards 5 include wiring boards 52, on each of which a plurality of LEDs (light-emitting elements) 51 are mounted. The wiring boards 52 have a long shape (a long strip-like rectangular shape), and are preferably made of printed boards. The LEDs 51 are electrically connected in series to each other by wiring patterns 53 of each wiring board 52. The LEDs 51 are mounted on each wiring board 52 and aligned in a longitudinal direction of each wiring board 52 while spaced apart from each other (e.g., at regular intervals).

LED chips themselves, or LED packages that include LED chips are preferably used as the LEDs 51. Each LED package has a configuration such that an LED chip is encapsulated in a transparent resin, and electrodes for sending electricity to the LED chip are mounted on a surface of the resin. Known LED packages arranged to emit white light are used as the present LED packages.

It is preferable to use an LED as the LED 51, which has a configuration such that a blue light-emitting chip is coated with a fluorescent material that has an emission peak wavelength in a yellow region so as to emit white light. Because objects having high reflectivity in a yellow region (e.g., sheet metals, connectors) are often disposed around covering pieces 62 of the reflection sheet 6, it is preferable to use the LEDs that have wavelength characteristics in the yellow region because the amount of the light can be increased to improve luminance unevenness (dark regions). It is preferable that a sealing section for sealing the fluorescent material of each LED 51 has a dome structure.

Power supply connectors 54 are each disposed at end portions in the longitudinal directions of the LED boards 5 so as to protrude from surfaces of the LED boards (so as to have a convex shape). Each power supply connector 54 mainly includes a housing 55 having a box shape in appearance, and two terminals (not illustrated) housed in the housing 55. One of the two terminals is a power terminal (anode terminal), and the other is a ground terminal (cathode terminal). The housings 55 are made from a plastic material such as polypropylene and polystyrene, and have spaces inside to house the terminals. In the present embodiment, the power supply connectors 54 are larger than the LEDs 51, and disposed on the LED boards 5 so as to protrude more forward than the LEDs 51.

Cable connectors (not illustrated) that are connected to a power board 12 via cables (not illustrated) are each fitted and connected to the power supply connectors 54. The power board 12 is disposed behind the backlight chassis 4, and arranged to supply power to the LED boards 5. The brightness (luminance) of the LEDs 51 on the LED boards 5 is adjusted to be equal to one another.

The LED boards 5 are fixed to the wall plates 42 of the backlight chassis 4 by fixing means (not illustrated, e.g., screws) so as to erect with respect to the bottom plate 41 of the backlight chassis 4, i.e., so that the wiring boards 52 are disposed perpendicular to the bottom plate 41. The LED boards 5 may be fixed directly to the wall plates 42 of the backlight chassis 4, or may be fixed thereto by additional members.

In the present embodiment, the LED boards 5 are fixed to the wall plates 42 that correspond to the two long sides of the bottom plate 41 among the wall plates 42 surrounding the bottom plate 41. The LED boards 5 are opposed to each other inside the box-shaped (container-shaped) backlight chassis 4. In the present embodiment, two LED boards 5 are fixed side by side to each wall plate 42 as shown in FIG. 1. The power supply connectors 54 on the LED boards 5 are disposed at positions corresponding to the four corners of the light guide plate 7.

The reflection sheet 6 is laid on the bottom plate 41 of the backlight chassis 4. The reflection sheet 6 is disposed so as to cover a back face (lower face) 73 of the light guide plate 7 that is disposed over the reflection sheet 6. The reflection sheet 6 has a rectangular shape so as to correspond with the shape of the light guide plate 7. The reflection sheet 6 defines a white expanded resin sheet (e.g., an expanded polyethylene terephthalate sheet).

The reflection sheet 6 includes a main body 61 disposed parallel to the bottom plate 41 of the backlight chassis 4, and the covering pieces 62 arranged to cover surfaces of the convex-shaped power supply connectors 54 on the LED boards 5. The light guide plate 7 is disposed on the main body 61 of the reflection sheet 6.

In the present embodiment, the covering pieces 62 are provided on the four corners of the reflection sheet 6 (the main body 61). Each covering piece 62 has a rectangular shape (strip shape), and is capable of bending at its root, which is a border between the main body 61 and the covering piece 62, and at a section more front than the root. The covering pieces 62 each include portions 63 that bend at the roots to be raised with respect to the bottom plate 41 so as to mainly cover front faces of the power supply connectors 54 (the faces that face end faces 711 of the light guide plate 7), and portions 64 that bend at borders between the portions 63 and the portions 64 to be disposed parallel to the bottom plate 41 so as to mainly cover upper faces (top faces) of the power supply connectors 54. The portions 64 of the covering pieces 62 are sandwiched between the frame 11 that covers the wall plates 42 of the backlight chassis 4, and the housings 55 of the power supply connectors 54 as shown in FIG. 2, and thus positioning of the portions 64 is made. While the reflection sheet 6 expands or contracts by heat, raising the possibility that the positions of the covering pieces 62 are deviated so as not to cover the power supply connectors 54 depending on the use environment, the positional deviation can be reduced because the positioning of the covering pieces 62 is made as described above.

The light guide plate 7 has a rectangular shape as a whole when seen in a plan view. The light guide plate 7 defines a plate member made from a clear material such as an acrylic resin, which is about 3 to 4 mm in thickness. In the present embodiment, light emitted from the LEDs 51 on the LED boards 5 enters from two end faces 71 on the long sides of the light guide plate 7.

The light guide plate 7 includes a plurality of scattering members 74 in a dot pattern that are disposed on a front face (upper face) 72 of the light guide plate 7. The scattering members 74 are preferably provided thereon by dotting paint containing a white pigment on the front face 72 of the light guide plate 7 in a silk screening printing method, or are preferably provided thereon by forming concave portions (i.e., frosting) on the front face 72 of the light guide plate 7, which are formed by shaving the front face 72. The light guide plate 7 is locked by locking pins (not illustrated) erecting from the bottom plate 41, and is thus positioned with respect to the chassis 4.

The light guide plate 7 includes notches 75P on its four corners. Each notch 75P is partitioned by two end faces 711 and 712 of the light guide plate 7. The end faces 711 are parallel to the end faces 71 in the longitudinal direction of the light guide plate 7, and are disposed more behind (closer to the center) than the end faces 71. Meanwhile, the end faces 712 are parallel to end faces 76 in the short direction of the light guide plate 7, and are disposed more behind (closer to the center) than the end faces 76.

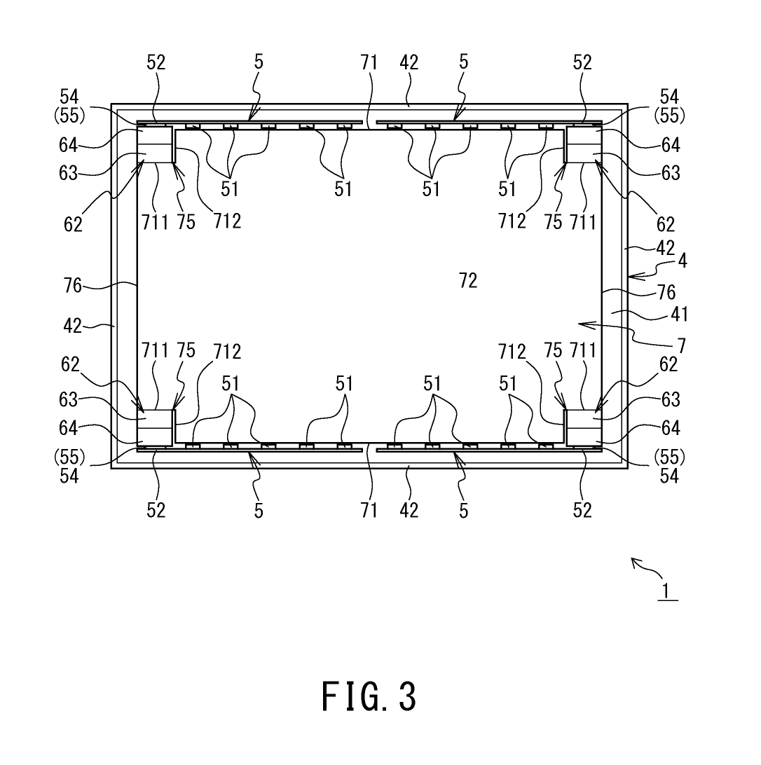

FIG. 3 is a plan view showing a schematic configuration of the illuminating device 1. The optical sheets 8 to 9 and the frame 11 are not illustrated in FIG. 3 for the sake of illustration. The LED boards 5 are disposed facing the end faces 71 such that the power supply connectors 54 are each housed in the notches 75 of the light guide plate 7 as shown in FIG. 3. The covering pieces 62 of the reflection sheet 6 that are raised with respect to the bottom plate 41 of the chassis 4 cover the surfaces of the power supply connectors 54.

The optical sheets 8 to 10 are disposed on the front face 72 of the light guide plate 7 as shown in FIGS. 1 and 2. The optical sheets 8 to 10 define resin sheets, each of which has a rectangular shape, and is about 0.1 to 0.5 mm in thickness. The optical sheets 8 to 10 are stacked on the front face 72 of the light guide plate 7.

The optical sheet 8 defines a so-called diffusion sheet, and is arranged to diffuse the light emitted from the front face 72 of the light guide plate 7 to allow uniformalization of luminance distribution of the light. The optical sheet 9 defines a so-called lens sheet, and is arranged to gather the light emitted from the diffusion sheet (optical sheet 8) to allow enhancement of front brightness of the light. The optical sheet 10 defines a so-called polarization selective reflection sheet, and is arranged to selectively reflect the light emitted from the lens sheet (optical sheet 9) so that the light is not absorbed by a polarizing plate (not illustrated) that is attached on the lower side of the liquid crystal display panel 2.

The frame 11 has a frame shape. The frame 11 is arranged to cover the chassis 4 that houses the stack of the optical sheets 8 to 10, the light guide plate 7 and the reflection sheet 6. The frame 11 is attached and fixed to the wall plates 42 of the backlight chassis 4 so as to cover front ends of the wall plates 42 of the backlight chassis 4, and front ends in the short directions of the LED boards 5. The frame 11 is prepared, for example, by processing a known member made from a metallic or a plastic material so as to have a predetermined shape. The liquid crystal display panel 2 is disposed on the frame 11.

The liquid crystal display panel 2 consists of two glass substrates that are bonded together while sandwiching a liquid crystal material (a liquid crystal layer) therebetween. One of the glass substrates defines a TFT (Thin Film Transistor) substrate and the other defines a CF (Color Filter) substrate. The liquid crystal display panel 2 is arranged to receive planar light that is projected onto its back face 21 from the illuminating device 1, and display an image on its front face 22 using the light. The liquid crystal display panel 2 is electrically connected to and driven by a control circuit board 13 that is disposed behind the illuminating device 1.

The bezel 3 has a frame shape, and is larger than the frame 11. The bezel 3 is arranged to cover peripheral portions of the liquid crystal display panel 2. The bezel 3 and the frame 11 sandwich the liquid crystal display panel 2 therebetween. Thus, the bezel 3 is fixed to the backlight chassis 4, and is, together with the backlight chassis 4, arranged to ensure strength of the entire liquid crystal display device 100. The bezel 3 is prepared, for example, by processing a known material such as a metallic or a plastic material so as to have a predetermined shape.

A description of the principle on which luminance unevenness is prevented from developing in the illuminating device 1 of the present embodiment will be provided with reference to FIGS. 2 and 3. When the LEDs 51 on the LED boards 5 are turned on, the light emitted from the LEDs 51 enters the light guide plate 7 mainly from the end faces 71 of the light guide plate 7. The entering light travels inward (farther) in the light guide plate 7 while repeatedly reflected by the front and back faces 72 and 73 of the light guide plate 7, and is emitted from the front face 72 of the light guide plate 7.

A part (light L1) of the light that enters from the end faces 71 gets (leaks) out of the light guide plate 7 via the end faces 711 of the notches 75 as described above. However, in the present embodiment, the light L1 that has got (leaked) out is reflected by the covering pieces 62 that cover the surfaces of the housings 55 of the power supply connectors 54, and is, referred to as light L2, made to reenter the light guide plate 7 from the end faces 711. Thus, by making the light reenter the light guide plate 7 with the use of the covering pieces 62, the vicinities of the power supply connectors 54 can be made brighter (luminance in the vicinities of the power supply connectors 54 can be increased).

In the present embodiment, when the end faces 711 and 712 of the light guide plate 7 that partition the notches 75 are compared with each other, the light emitted from the end faces 711 has a larger influence over luminance unevenness than the light emitted from the end faces 712. This is because, while the light-emitting elements (LEDs) 51 that are capable of compensating for the leaked light are disposed in the vicinities of the end faces 712, no light-emitting element (LEDs) 51 is disposed in the vicinities of the end faces 711. Therefore, it is preferable, from the viewpoint of preventing luminance unevenness, to cover at least the surfaces of the power supply connectors 54 that face the end faces 711 as shown in FIG. 1.

The covering pieces 62 of the reflection sheet 6 are required to have higher reflectivity than the surfaces of the non-light-emitting elements such as the surfaces of the power supply connectors 54 (the surfaces of the housings 55).

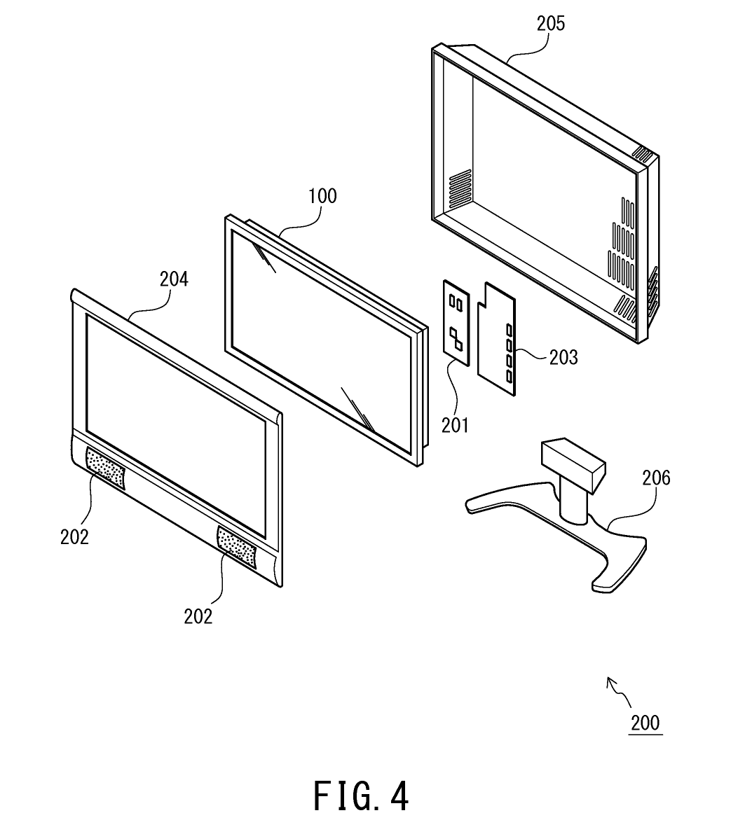

The liquid crystal display device 100 of the present embodiment is used preferably in a television receiving device. A description of a television receiving device of a preferred embodiment of the present invention will be provided with reference to FIG. 4. FIG. 4 is an exploded perspective view showing a schematic configuration of the television receiving device of the present embodiment. A television receiving device 200 includes the liquid crystal display device 100, a tuner 201, loudspeaker units 202, an electric power supply 203, a front side cabinet 204, a back side cabinet 205, and a supporting member 206. The television receiving device 200 includes the liquid crystal display device 100 including the edge light type illuminating device 1.

The tuner 201 is arranged to produce an image signal and a sound signal of a given channel based on a received radio wave. A conventional terrestrial tuner (analog and/or digital), a BS tuner and a CS tuner are preferably used as the tuner 201.

The loudspeaker units 202 are arranged to produce a sound based on the sound signal produced by the tuner 201. Generally-used speakers are preferably used as the loudspeaker units 202.

The electric power supply 203 is arranged to supply electric power to the liquid crystal display device 100, the tuner 201, the loudspeaker units 202 and other components.

The liquid crystal display device 100, the tuner 201, the loudspeaker units 202 and the electric power supply 203 are sandwiched between the front side cabinet 204 and the back side cabinet 205, and housed therein, which are supported by the supporting member (i.e., stand) 206.

Including the illuminating device 1, the television receiving device 200 of the present embodiment is capable of preventing luminance unevenness from developing therein.

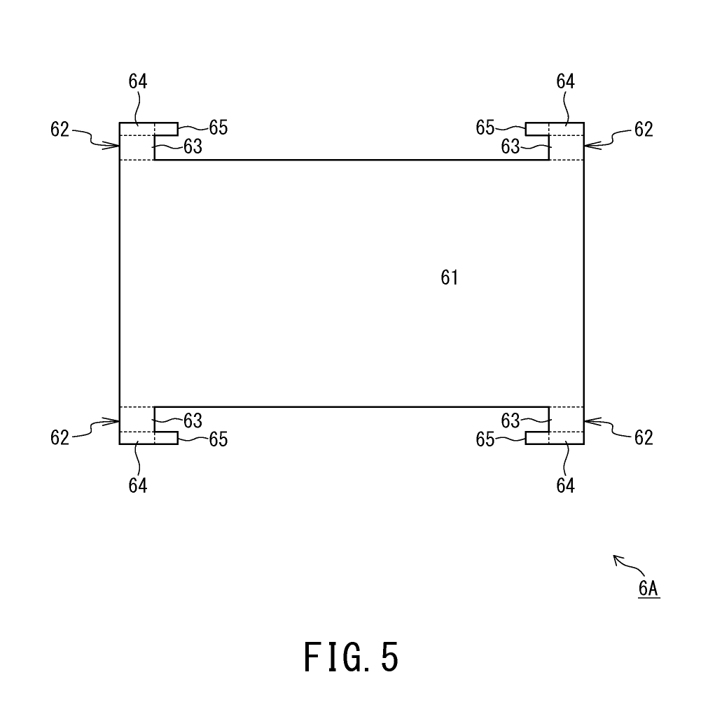

Hereinafter, descriptions of other preferred embodiments of the present invention will be provided with reference to FIGS. 5 to 8. FIG. 5 is a plan view showing a schematic configuration of a reflection sheet 6A that is used in an illuminating device of another preferred embodiment of the present invention. The reflection sheet 6A is used in an illuminating device having a similar configuration to the illuminating device shown in FIG. 1. The reflection sheet 6A includes a main body 61 having a rectangular shape, and four covering pieces 62 disposed on the four corners of the main body 61. The covering pieces 62 each include portions 63 that extend from sides of the main body 61 to bend at their roots to be raised with respect to the bottom plate 41 of the backlight chassis 4 so as to mainly cover the front faces of the power supply connectors 54 (the faces that face the end faces 711 of the light guide plate 7), and portions 64 that bend at borders between the portions 63 and the portions 64 to be disposed parallel to the bottom plate 41 so as to mainly cover the upper faces (top faces) of the power supply connectors 54. Further, portions 65 that are arranged to cover lateral faces of the power supply connectors 54 are provided extending from the portions 64. The portions 65 have a strip shape, and cover the lateral faces of the power supply connectors 54 by bending at borders between the portions 64 and the portions 65 so as to hang from the portions 64.

The portions 65 of the covering pieces 62 are arranged to mainly make the light, which has got (leaked) out of the light guide plate 7 via the end faces 712 of the notches 75 shown in FIGS. 2 and 3, reenter the light guide plate 7. Thus, the light, which has got (leaked) out of the light guide plate 7 via the end faces 712, can be reflected to be further made to reenter the light guide plate 7 by covering the lateral faces of the power supply connectors 54 (the faces that face the end faces 712 of the light guide plate 7) with the portions 65, which can further prevent luminance unevenness.

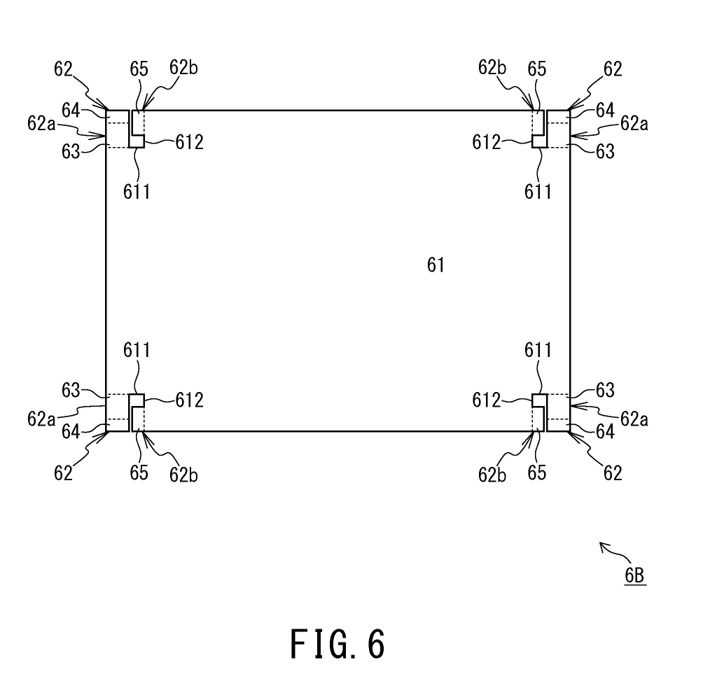

FIG. 6 is a plan view showing a schematic configuration of a reflection sheet 6B that is used in an illuminating device of another preferred embodiment of the present invention. The reflection sheet 6B is used in an illuminating device having a similar configuration to the illuminating device shown in FIG. 1. The reflection sheet 6B has a rectangular shape as a whole. The reflection sheet 6B includes a main body 61 having a shape such that quadrangular-shaped portions on the four corners of the main body 61 are removed. The main body 61 includes sides 611 that are parallel to the long sides of the reflection sheet 6B, and sides 612 that are parallel to the short sides. Portions 62a of covering pieces 62 having a strip shape are provided extending from the sides 611. The portions 62a each include portions 63 that are arranged to cover the front faces of the power supply connectors 54, and portions 64 that are arranged to cover the upper faces (top faces) of the power supply connectors 54. Meanwhile, portions 62b of the covering pieces 62 are provided extending from the sides 612. The portions 62b each include portions 65 that are arranged to cover lateral faces of the power supply connectors 54. The portions 65 bend at borders at their roots (sides 612) to be raised with respect to the bottom plate 41 of the backlight chassis 4 so as to lean on the lateral faces of the power supply connectors 54, and thus positioning of the portions 65 is made.

As described above, it is also preferable to divide each covering piece 62 arranged to cover the faces of each power supply connector 54 into a plurality of pieces so as to correspond to the faces of each power supply connector 54, and to provide the plurality of pieces to the main body 61 of the reflection sheet 6.

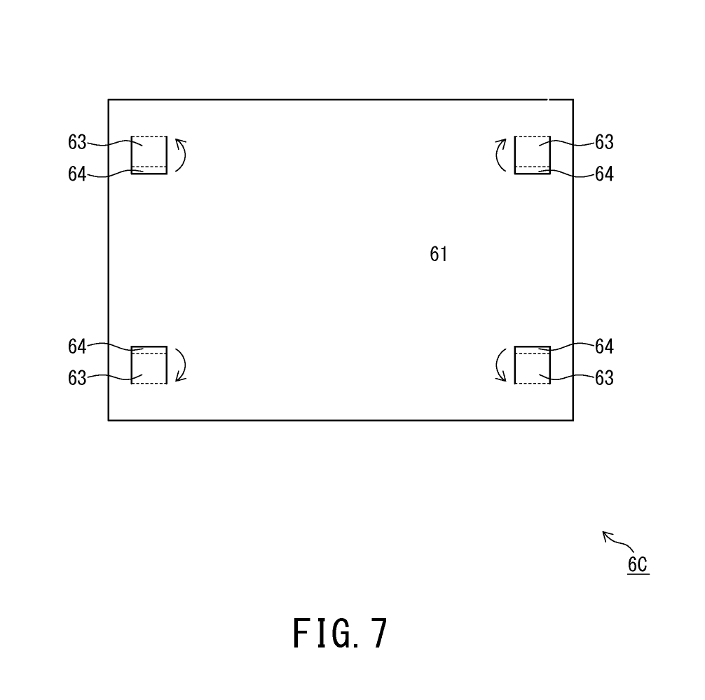

FIG. 7 is a plan view showing a schematic configuration of a reflection sheet 6C that is used in an illuminating device of another preferred embodiment of the present invention. The reflection sheet 6C is used in an illuminating device having a similar configuration to the illuminating device shown in FIG. 1. The reflection sheet 6C includes a main body 61 having a rectangular shape. Covering pieces 62 having a rectangular shape (strip shape) are provided on the four corners of the main body 61 by forming slits in the main body 61 on the sides surrounding the covering pieces 62 except one sides at the roots of the covering pieces 62. The covering pieces 62 are bent at their roots so as to be raised from the main body 61, and further bent at more front side portions. Foremost portions of the covering pieces 62 define portions 64 that are arranged to cover the upper faces (top faces) of the power supply connectors 54. Portions of the covering pieces 62 that are closer to the roots than the portions 64 define portions 63 that are arranged to cover the front faces of the power supply connectors 54. The portions 63 of the covering pieces 62 shown in FIG. 7 are disposed such that the back faces of the portions 63 face the end faces 711 of the light guide plate 7.

As described above, it is also preferable to provide the covering pieces 62 by making the slits in the main body 61 to raise the covering pieces 62 from the main body 61.

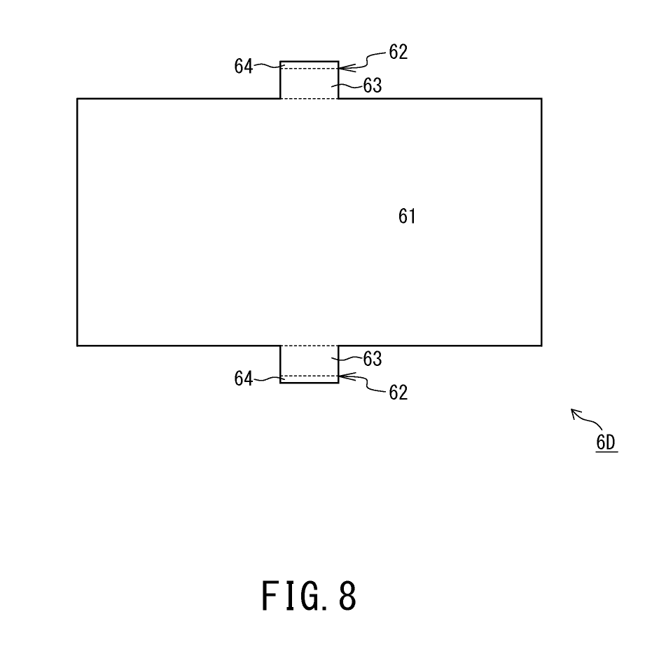

FIG. 8 is a plan view showing a schematic configuration of a reflection sheet 6D that is used in an illuminating device of another preferred embodiment of the present invention. The reflection sheet 6C includes a main body 61 having a rectangular shape. The main body 61 includes covering pieces 62 having a strip shape that each extend from the two long sides of the main body 61. The reflection sheet 6C is used in an illuminating device that includes the LED boards 5 including the power supply connectors 54 that are disposed in the middle of the LED boards 5, not on the four corners of the light guide plate 7. As described above, the positions of the covering pieces 62 on the reflection sheet 6C are changed appropriately depending on the positions of the power supply connectors 54 on the LED boards 5.

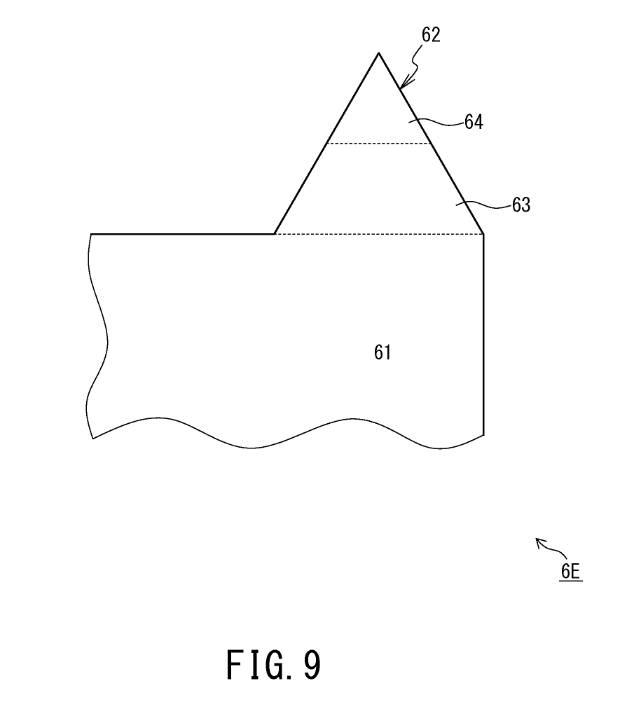

Hereinafter, descriptions of other preferred embodiments of the present invention will be further provided with reference to FIGS. 9 to 15. FIG. 9 is a plan view showing a schematic partial configuration of a reflection sheet 6E that is used in an illuminating device of another preferred embodiment of the present invention. The shape of covering pieces 62 of the reflection sheet 6E is determined appropriately by the shape of the non-light-emitting elements that the covering pieces 62 are to cover. For example, when the non-light-emitting elements that the covering pieces 62 are to cover have a triangular shape, the covering pieces 62 preferably have a triangular shape as shown in FIG. 9.

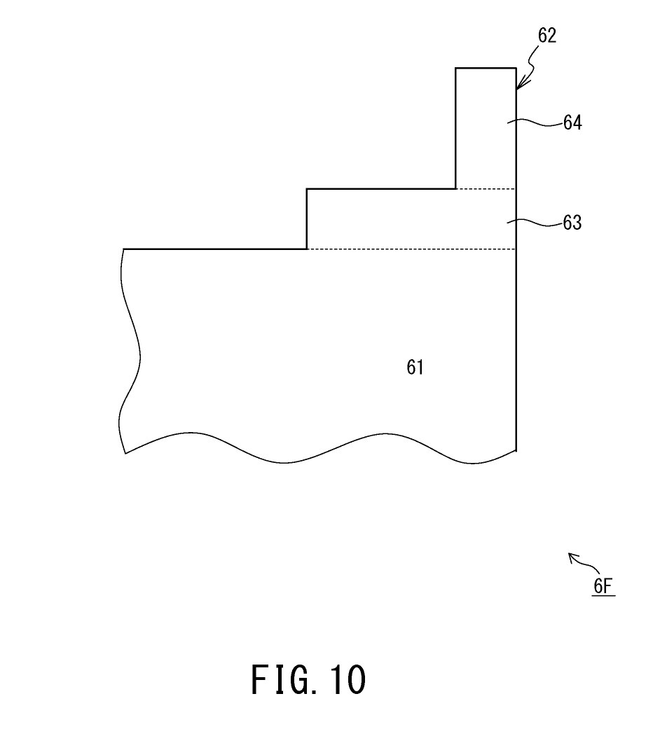

FIG. 10 is a plan view showing a schematic partial configuration of a reflection sheet 6F that is used in an illuminating device of another preferred embodiment of the present invention. Covering pieces 62 of the reflection sheet 6F have the shape of the letter “L” as a whole so as to correspond with the shape of the non-light-emitting elements that the covering pieces 62 are to cover.

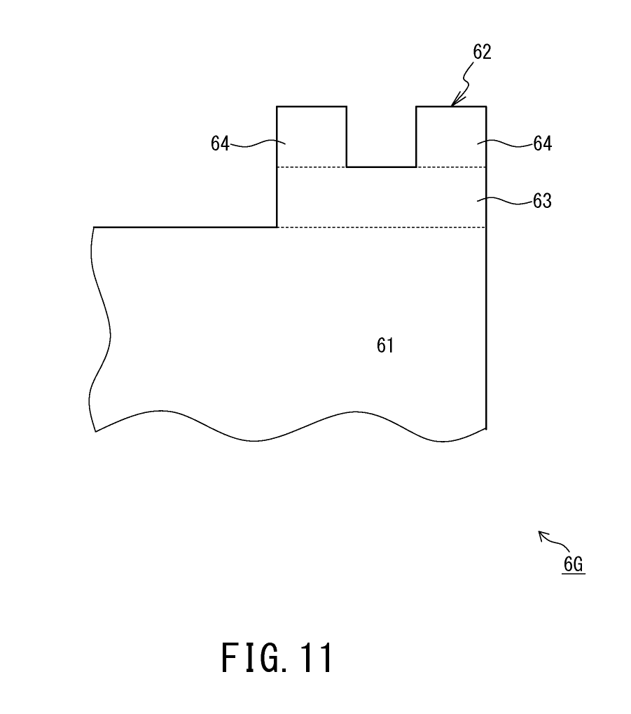

FIG. 11 is a plan view showing a schematic partial configuration of a reflection sheet 6G that is used in an illuminating device of another preferred embodiment of the present invention. Covering pieces 62 of the reflection sheet 6G have a concave shape as a whole so as to correspond with the shape of the non-light-emitting elements that the covering pieces 62 are to cover.

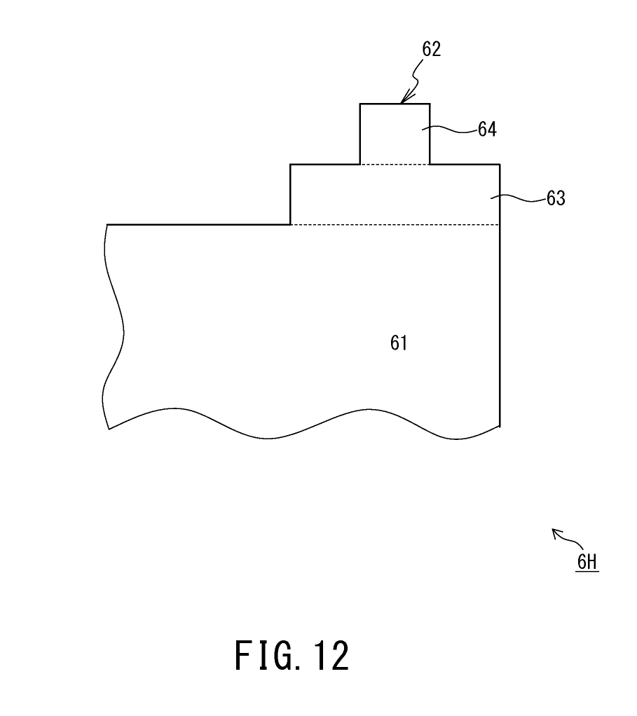

FIG. 12 is a plan view showing a schematic partial configuration of a reflection sheet 6H that is used in an illuminating device of another preferred embodiment of the present invention. Covering pieces 62 of the reflection sheet 6H have a convex shape as a whole so as to correspond with the shape of the non-light-emitting elements that the covering pieces 62 are to cover.

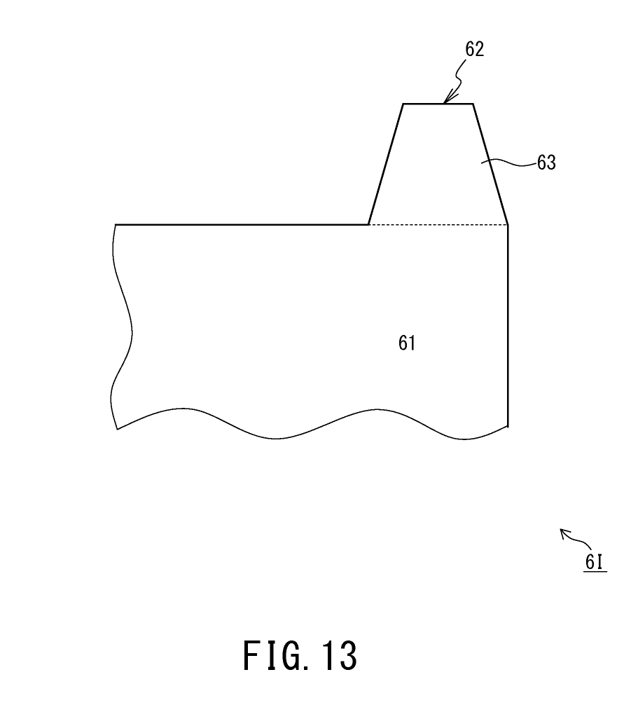

FIG. 13 is a plan view showing a schematic partial configuration of a reflection sheet 6I that is used in an illuminating device of another preferred embodiment of the present invention. Covering pieces 62 of the reflection sheet 6I have a taper shape such that the covering pieces 62 taper to directions receding from the bottom plate 41 of the backlight chassis 4. That is, the covering pieces 62 have a shape such that when raised to erect with respect to the bottom plate 41 of the backlight chassis 4, the covering pieces 62 become smaller in width in the erecting directions.

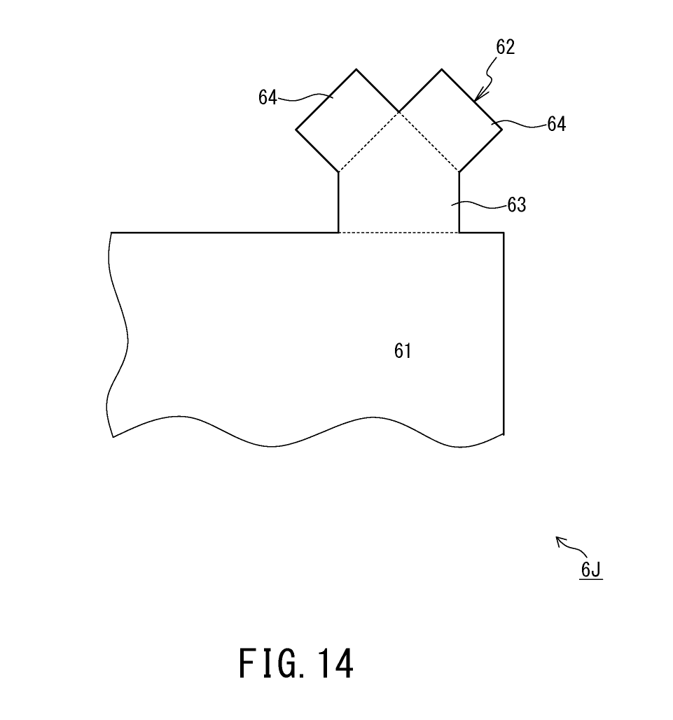

FIG. 14 is a plan view showing a schematic partial configuration of a reflection sheet 6J that is used in an illuminating device of another preferred embodiment of the present invention. Covering pieces 62 of the reflection sheet 6J have a bifurcated shape at their front ends.

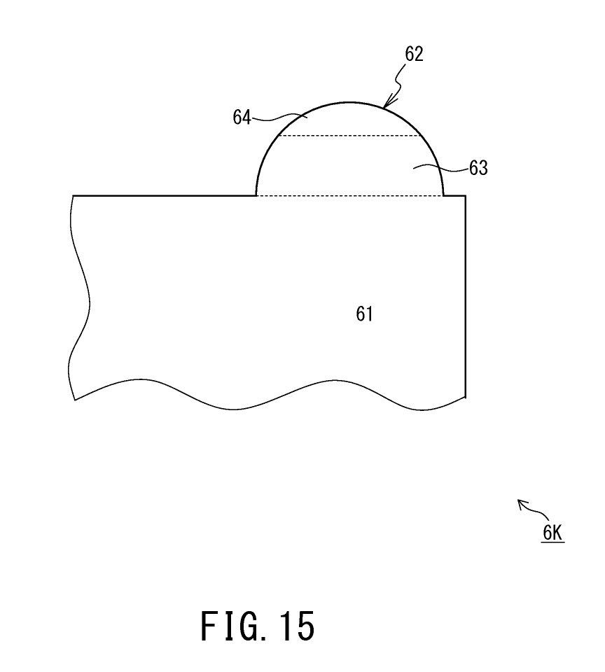

FIG. 15 is a plan view showing a schematic partial configuration of a reflection sheet 6K that is used in an illuminating device of another preferred embodiment of the present invention. Covering pieces 62 of the reflection sheet 6K have a shape such that their outer edges are curved. Generally, the covering pieces 62 having the curved outer edges are easy to produce by a punching operation. Meanwhile, the covering pieces 62 having linear outer edges (e.g., the covering pieces 62 of the reflection sheet 6A) are easy to produce by plotter cutting.

In another preferred embodiment, it is also preferable that the light-emitting boards 5 of the illuminating device 1 are disposed on only one end face of the rectangular-shaped light guide plate 7, or disposed on three of more than three end faces. In addition, it is preferable that the light-emitting boards 5 are disposed on the two end faces of the light guide plate 7 so as to face each other while sandwiching the light guide plate 7 therebetween as in the above-described embodiments, or disposed on the two adjacent end faces of the guide plate 7 (i.e., disposed so as to have the shape of the letter “L”).

In another preferred embodiment, it is also preferable that non-light-emitting elements other than the power supply connectors 54 on the light-emitting boards 5 are covered with the covering pieces 62 of the reflection sheet 6, whereby the reflectivity in the non-light-emitting elements are increased to improve the luminance in the vicinities of those non-light-emitting elements.

The covering pieces 62 and the main body 61 of the reflection sheet 6 may be of a monolithic construction, or may be of a multi-component assembled construction.

The reflectivity of the main body 61 of the reflection sheet 6 and the reflectivity of the covering pieces 62 may be about same, or the reflectivity of the covering pieces 62 may be higher than that of the main body 61. For example, the reflectivity of the covering pieces 62 can be increased by attaching films made from a material having reflectivity higher than the main body 61 to the surfaces of the covering pieces 62.

In another preferred embodiment, it is also preferable that the covering pieces 62 of the reflection sheet 6 are fixed to the non-light-emitting elements (the housings 55 of the power supply connectors 54) with a known adhesive agent.

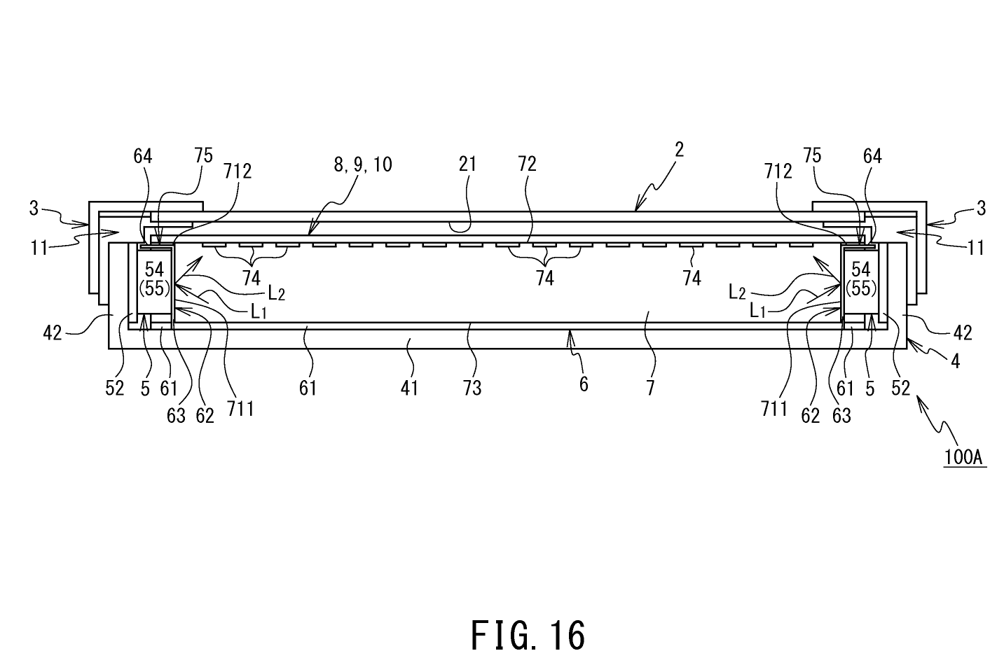

FIG. 16 is an explanatory view showing a schematic cross-sectional configuration of a liquid crystal display device 100A of another preferred embodiment of the present invention. In the liquid crystal display device 100A, the covering pieces 62 of the reflection sheet 6 are positioned by being sandwiched between the non-light-emitting elements (the housings 55 of the power supply connectors 54) and the light guide plate 7. In the liquid crystal display device 100A, the end faces 711 at the notches 75 of the light guide plate 7 are disposed very close to the surfaces of the housings 55. Thus, the covering pieces 62 (the portions 63 of the covering pieces 62) of the reflection sheet 6 can be sandwiched and fixed between the end faces 711 and the surfaces of the housings 55 so as not to move more than necessary. This configuration can reduce the amount of light that leaks out of the end faces 711, and also allows the covering pieces 62 and the reflection sheet 6 to be positioned.

1. An illuminating device comprising:
a backlight chassis having a container shape, the chassis comprising:
a bottom plate; and
wall plates surrounding the bottom plate;
a reflection sheet laid on an inner bottom face of the backlight chassis;
a light guide plate disposed on the reflection sheet, and arranged to guide light that enters from its end faces inward and emit the light from its upper face;
light-emitting boards, each of which comprises:
a wiring board;
a plurality of light-emitting elements aligned on the wiring board; and
a non-light-emitting element having a convex shape, and disposed on the wiring board, wherein the light-emitting elements and the non-light-emitting elements are disposed between the wall plates of the backlight chassis and the light guide plate, while facing the end faces of the light guide plate; and
a frame having a frame shape and arranged to cover upper ends of the wall plates of the backlight chassis while covering peripheral portions of the light guide plate, wherein the reflection sheet comprises covering pieces disposed on its peripheral portions, and arranged to cover surfaces of the non-light-emitting elements on the light-emitting boards.

2. The illuminating device according to claim 1,
wherein the non-light-emitting elements on the light-emitting boards comprise power supply connectors arranged to supply electric power to the light-emitting elements.

3. The illuminating device according to claim 2,
wherein the power supply connectors are disposed at both ends of the light-emitting boards, and wherein the covering pieces arranged to cover the power supply connectors are disposed on four corners of the reflection sheet.

4. The illuminating device according to claim 2,
wherein the light guiding plate comprises notches disposed on its four corners, and arranged to house the power supply connectors on the light-emitting boards, and wherein the power supply connectors are covered by the covering pieces while housed in the notches.

5. The illuminating device according to claim 2,
wherein the power supply connectors are disposed in the middle in longitudinal directions of the light-emitting boards, and wherein the covering pieces arranged to cover the power supply connectors are disposed at positions of the reflection sheet, the positions corresponding to the power supply connectors.

6. The illuminating device according to claim 1, wherein front ends of the covering pieces are sandwiched and held between the frame-shaped frame and the non-light-emitting elements on the light-emitting boards.

7. The illuminating device according to claim 1, wherein the covering pieces are provided by forming slits inside outer edges of the reflection sheet.

8. The illuminating device according to claim 1, wherein the covering pieces have any one of a triangular shape and a quadrangular shape.

9. The illuminating device according to claim 1, wherein the covering pieces have the shape of the letter L.

10. The illuminating device according to claim 1, wherein the covering pieces have any one of a convex shape and a concave shape.

11. The illuminating device according to claim 1, wherein the covering pieces have a taper shape such that the covering pieces taper to directions receding from the bottom plate.

12. The illuminating device according to claim 1, wherein the covering pieces have a bifurcated shape at their front ends.

13. The illuminating device according to claim 1, wherein the covering pieces have any one of a curved shape and a linear shape.

14. The illuminating device according to claim 1, wherein the covering pieces and the reflection sheet are of a multi-component assembled construction.

15. The illuminating device according to claim 1, wherein the covering pieces are fixed to the non-light-emitting elements with an adhesive member.

16. The illuminating device according to claim 1, wherein the covering pieces are sandwiched and fixed between the non-light-emitting elements and the light guide plate.

17. The illuminating device according to claim 1, wherein the reflection sheet has reflectivity higher than the surfaces of the non-light-emitting elements.

18-21. (canceled)

22. A liquid crystal display device comprising:
the illuminating device according to claim 1; and
a transmissive or transflective liquid crystal display panel,
wherein the illuminating device is disposed on a back-face side of the liquid crystal display panel, and planar light emitted from the illuminating device is projected onto the back-face side of the liquid crystal display panel.

23. A television receiving device that comprises the liquid crystal display device according to claim 22.
